(19) United States
(12) Patent Application Publication
(10) Pub. No.: US 2007/0077929 A1
(43) Pub. Date: Apr. 5, 2007

(54) Method for implementing macro-diversity management by using intelligent vbs

(75) Inventors: Xiyuan Chen, Shenzhen (CN); Bill Huang, Shenzhen (CN); Zhiyu Xu, Shenzhen (CN)

Correspondence Address: LADAS & PARRY, 26 WEST 61ST STREET, NEW YORK, NY, 10023, US

(73) Assignee: UTSTARCOM (CHINA) CO., LTD., BEIJING 100027 (CN)

(21) Appl. No.: 10/554,304

(22) PCT Filed: Apr. 25, 2003
(86) PCT No.: PCT/CN03/00305

§ 371 Date: Oct. 6, 2006

(51) Int. Cl. H04Q 7/20

(52) U.S. Cl. 455/445

(57) ABSTRACT

The present application discloses a method for implementing macro-diversity management by using intelligent VBS the size of a cell cluster is intelligently adjusted by using a mobile server, and the macro-diversity of the cell cluster is performed by dynamically selecting a parent base station. Specifically, according to load condition of a cell in the cluster, the most effective cell is selected as the parent base station so as to balance inter-cell load balancing. Furthermore, since different VBSs can exchange information through the mobile server, the intelligent VBS hierarchy can perform inter-cell cluster and inter-VBS macro-diversity. Such an intelligent VBS hierarchy can avoid a plurality of Iur interface signalings due to frequent handover between radio network controllers (RNC), and balance load imbalance due to inter-cell soft handover.

### TECHNCIAL FIELD

The present invention relates to a method for implementing macro-diversity management by using intelligent VBS.

### BACKGROUND ART

The concept of virtual base station (VBS) was originally applied in ad hoc mobile network. VBS hierarchy generation protocol defines a dynamic mobile network, to simulate the functionality of fixed hierarchy of conventional cellular mobile network. Recently, DoCoMo proposes a dynamic VBS technique applied to cellular mobile network, and the technique performs macro-diversity of cell cluster by dynamically changing size of cell cluster (that is, a set of cell) and dynamically selecting parent base station. Compared to the fixed cell hierarchy in the third generation mobile communication network (3G Release 99), the dynamic VBS technique can dynamically adjust size of a cell cluster according to load condition and handover condition of a cell, whereby flexibly performing macro-diversity and balancing load of cells. However, such a dynamic VBS technique fails to clearly disclose specific technical solution, for example, by means of which principle the size of cell cluster is adjusted and how to adjust.

### SUMMARY OF THE INVENTION

In connection with the technical problem in the prior art, the present invention proposes a method for implementing macro-diversity management by using intelligent VBS, so as to perform macro-diversity management in clusters having different size.

in different size of cell cluster.

The present invention provides a method for implementing macro-diversity management by using intelligent VBS, wherein each VBS area includes a plurality of cell clusters and each VBS area corresponds to one mobile server, and the mobile server contains load information and handover information of all cells included in the VBS area, the method comprising the steps of:

base station in a cell cluster, which has highest load and highest normalized handover rate, is selected as parent base station, and the selected parent base station performs macro-diversity on signals from a same user equipment received by all cells of the cell cluster;

selection of cluster is made based on the following minimized target cost functions:

$${c}_{1} {\sum }_{k} {sc}_{k} + {c}_{2} {\sum }_{i} {\sum }_{j} {h}_{ij} {z}_{ij} + {c}_{3} {\sum }_{i} {\sum }_{j} {h}_{ij} ( {w}_{ij} - {z}_{ij} ) . \qquad ( 1 )$$

where:

$${\sum }_{k} {x}_{ik} = 1 , for all i , \qquad ( 2 )$$

wijk≦xik, wijk≦xjk, wijk≧xik+xjk−1, for all i, j and k (3)
zijm≦xik, zijm≦xjm, zijm≧xim+xjm−1, for all i, j and m (4)

$$\begin{matrix}{\sum }_{i ∈ S {1}_{k}} {\sum }_{j ∈ S {2}_{k}} {B}_{ij} \geq 1 & ( 5 ) \\ {\sum }_{i} {\sum }_{i ≺ j} {w}_{ij} {B}_{ij} \leq CI {\sum }_{i} {\sum }_{i ≺ j} {B}_{ij} & ( 6 )\end{matrix}$$
where:
c, c2 and c3 represent respective weights of these three cost functions in total cost function, and c1+c2+c3=1;
i, j denote cells i and j;
k denotes a cell cluster, and m denotes VBS;
SCₖ is soft capacity of cell cluster k;
hᵢⱼ is handover loading from cell i to cell j;
zᵢⱼ=1−Σₘzᵢⱼₘ, where zᵢⱼₘ is a binary variable, and when cells i and j belong to VBS m, zᵢⱼₘ=1;
wᵢⱼ=1−Σₖwᵢⱼₖ, where wᵢⱼₖ is a binary variable, and when cells i and j belong to cell cluster k, wᵢⱼₖ=1;
xᵢₖ is a binary variable, and when cell i belongs to cell cluster k, xᵢₖ=1;
xⱼₖ is a binary variable, and when cell j belongs to cell cluster k, xⱼₖ=1;
xᵢₘ is a binary variable, and when cell i belongs to VBS m, xᵢₘ=1;
xⱼₘ is a binary variable, and when cell j belongs to VBS m, xⱼₘ=1;
if cell i is adjacent to cell j, Bᵢⱼ=1;
S1ₖ is a subset of CBSₖ, that is, S1ₖ⊂CBSₖ, S1ₖ≠Ø and S1ₖ≠CBSₖ;
S2ₖ is a complementary set for S1ₖ, and S2ₖ=CBSₖ−S1ₖ;
CBSₖ is a set of cells included in cell cluster k.

The basic idea of the present invention is in that, the size of cell cluster is intelligently adjusted by using the mobile server, and the macro-diversity of cell cluster is performed by dynamically selecting the parent base station. Moreover, the mobile server possesses a database, which contains the load information and handover information of all cells included in a VBS area. Such an intelligent VBS hierarchy can avoid a plurality of Iur interface signalings due to frequent handover between radio network controllers (RNCs), and balance loads imbalance due to inter-cell soft handover.

### DESCRIPTIONS OF FIGURES

FIG. 1(a) shows HCS hierarchy of the prior art;

FIG. 1(b) shows the dynamic VBS hierarchy as proposed by DoCoMo;

FIG. 1(c) shows the intelligent VBS hierarchy in accordance with the macro-diversity management of the present invention;

FIG. 2 shows the conditions of cells of cluster being interconnected and being not interconnected; and

FIG. 3 shows that conditions of cells of a cluster being compact and being not compact.

### MODE FOR CARRYING OUT THE INVENTION

The method according to the present invention will be described below by means of the preferred embodiments in combination with the accompanying figures.

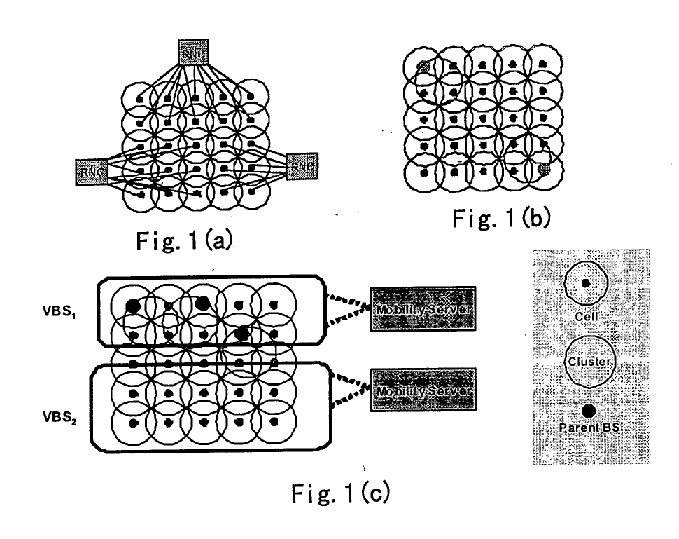

FIG. 1(a) shows HCS hierarchy of the prior art. It can be seen that the HCS hierarchy is fixed, moreover, size of each cell cluster is determined during the radio networking planning (RNP) and is kept along, and inter-cell macro-diversity can be performed through RNC.

FIG. 1(b) shows the dynamic VBS hierarchy as proposed by DoCoMo. It can be see from the figure that, in each cell cluster, the parent base station performs macro-diversity on signals from a same user equipment receiver by all children base stations of the cluster, and the number of the cells of the cluster can be dynamically adjusted in accordance with movement of user equipments (UE).

FIG. 1(c) shows the intelligent VBS hierarchy in accordance with the macro-diversity management of the present invention. Compared to the dynamic VBS technique as proposed by DoCoMo, the intelligent VBS hierarchy according to the present invention is relatively similar to the dynamic VBS technique as proposed by DoCoMo. However, the intelligent VBS hierarchy according to the present invention resolves the technical problem for implementing dynamic VBS, for example, how to plan the cluster and how to adjust size of the cluster. As shown in FIG. 1(c), each VBS area contains a certain number of cell clusters, and the mobile server possesses a database, which contains the load information and handover information of all cells included in a single VBS area.

In the intelligent VBS hierarchy according to the present invention, the size of the cell cluster is intelligently adjusted by using the mobile server, and the macro-diversity of cell cluster is performed by dynamically selecting the parent base station. Specifically, according to load condition of a cell of the cluster, the most effective cell is selected as parent base station so as to balance inter-cell load balancing. Furthermore, since different VBSs can exchange information through the mobile server, the intelligent VBS hierarchy can perform inter-cell cluster and inter-VBS macro-diversities, which can not be implemented in the dynamic VBS technique as proposed by DoCoMo.

Selection of Dynamic Parent Base Station

In the intelligent VBS hierarchy according to the present invention, the selection of parent base station is relatively simple. Each of VBS areas corresponds to one mobile server, and the mobile server contains handover data of all users in the VBS area and load condition of the cell. In a preferred embodiment of the present invention, the mobile server is actually a database which contains the load information and handover information of all cells included in the VBS area. Base stations of all cells of the VBS area are connected to mobile server in a wired manner (such as E1 or STM 1). Handover information of all users in a VBS area and load information of each cell are transmitted to the mobile server through base station, and the statistical information is obtained from the mobile station.

Usually, in case of the services being the same, the higher the handover rate, the heavier the loading of cell. When there is a multiple-services user in the cell, the user with higher data rate is normalized into several users with lower data rate. As a result, in each of cell clusters, the base station having highest load and highest normalized handover rate is selected as the parent base station, and the selected parent base station performs macro-diversity on signals from a same user equipment received by all cells of the cell cluster, so as to reduce requirements for transmit power of the user equipment, whereby decreasing interference level and load of uplink of cell. At the same time, the user equipment can reduce requirements for transmit power of the base station of each cell, whereby decreasing loading level of downlink. Please note that, the selection of the parent base station can be adaptively adjusted based on the information of load change and handover change collected by the mobile server and the change of size of cluster.

Strategy for Selection of Cluster

In the intelligent VBS hierarchy, the strategy for selection of cluster is very important. The present invention proposes some suitable strategies for selection of cluster for fulfilling requirements for soft capacity of different clusters and balancing inter-cluster load. In view of load balancing, the strategy for selection of cluster is closely related to load balancing and handover control. If there is no suitable strategy for selection of cluster, the case that the loading is not balanced may be exist, for example, the handover rate of some cells is too high, while the load of neighboring cells is too low. Moreover, inter-cluster and inter-VBS soft handovers are substantially reduced by means of suitable strategy for selection of cluster, whereby substantially reducing a plurality of Iur interface signalings due to inter-RNC handover in the conventional HCS hierarchy.

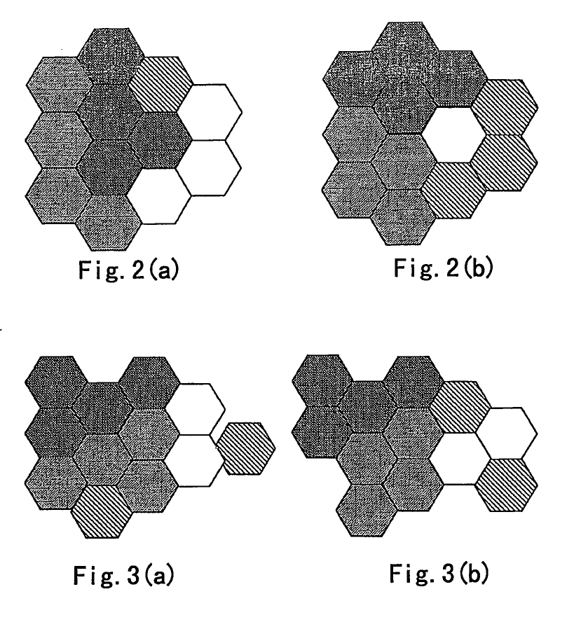

The first rule for selection of cluster is in that, the cells of the cluster should be inter-connected, because all of the children base stations (cBS) in the CDMA system simultaneously transmit signal in a same frequency band. As shown in FIG. 2, if these hexagonal cells are not interconnected as shown in FIG. 2(a), inter-cluster interference would be very intensive. Furthermore, the rule for selecting non-interconnected cells may lead to too many inter-cluster handover.

Secondly, in order to reduce too many inter-cluster handovers and too much interference, the cells within a single cluster should be compact to each other (that is, the cells shall be very closely to each other). As shown in FIG. 3(a), the cells within one cluster are inter-connected, but not compact, and one of the cells is surrounded by the cells of other clusters, which leads to that too many inter-cluster handovers and too much interference in this cell. In the cluster in which the cells are compact to each other, due to decrease of handover boundaries, the probability of inter-cluster handover is accordingly reduced. In order to evaluate the compactness of cells within a cluster, let us define a compactness indicator (CI) which is used to define the ratio of the number of boundaries of inter-cluster handover relative to the sum of boundaries of all cells in the cluster. In the case shown in FIG. 3(a), CI of all the clusters is equal to 14/24, while in the case shown in FIG. 3(b), CI of all the clusters is equal to 9/24.

Lastly, let us construct a hybrid cost function to balance inter-cluster load, and minimize inter-cluster handover probability and inter-VBS handover probability in which the cells are inter-connected and compact.

Assume that the constructions of all the clusters in a VBS area are known at time of t, the constructions of all clusters should be adaptively adjusted according to information in the mobile server at time of t+1. To this end, the following three cost functions shall be taken into consideration:

(1) cost for congesting call due to the load exceeding to soft capacity. It is known that the CDMA system is interference-limited, and the interference level becomes higher with the increase of the number of users. In order to ensure the call loss rate is less than a certain level, the interference level of the cell shall be controlled.

(2) cost for inter-VBS soft handover. When a user equipment being in progress of call is moves from one VBS to another VBS, such a user equipment need to perform inter-VBS soft handover by the aid of the mobile server. Obviously, the fewer the number of inter-VBS soft handover, the less the cost.

(3) cost for inter-cluster soft handover. When a user equipment being in progress of call is moves from one cluster to another cluster, such a user equipment need to perform inter-cluster soft handover. Obviously, the fewer the number of inter-cluster soft handover of, the less the cost.

Let us to construct a hybrid cost function based on above-mentioned cost functions.

Assume that the considered serving area contains N cells. The amount of traffic or load of each cell is denoted as TDᵢ, where i=1, . . . , Nₒ pᵢⱼ is a transfer probability from cell i to cell j of the user equipment, and the handover load from cell i to cell j is hᵢⱼ=pᵢⱼTDᵢ.

Meantime, assume that the serving are contains M VBSs, and SECₘ is set of clusters within VBSₘ, SCₖ is the soft capacity of cluster k, where k=1, . . . , K, and CBSₖ is a set of cells within cluster k. In order to clearly describe the cost function, we have to define some variables. For example, if cell i belongs to cluster k, a binary variable xᵢₖ=1 is defined. Assume yᵢₘ=Σ_{kεSEC}_{ₘ} xᵢₖ, if cell i belongs to VBSₘ, a binary variable yᵢₘ=1 is defined. If cells i and j belong to VBSₘ, a binary variable zᵢⱼₘ=1 is defined. Accordingly, the cost for inter-VBS soft handover is described by using a variable zᵢⱼ=1−Σₘzᵢⱼₘ. Please note that, if inter-VBS soft handover occurs, cells i and j belong to different VBSs, that is, zᵢⱼₘ=0. When cells i and j belong to cell cluster k, wᵢⱼₖ=1. To this end, the cost for inter-cluster soft handover can be calculated by using wᵢⱼ−zᵢⱼ, and wᵢⱼ=1−Σₖwᵢⱼₖ. If the inter-cluster soft handover merely occurs in the case that cells i and j, to which the user equipment is to be handover, belong to different clusters within a single same VBS, a variable scₖ is defined as scₖ=ΣᵢTDᵢxᵢₖ−SCₖ, which denotes difference between load requirement and soft capacity in cell k. After these variable have been defined, minimized target cost function, which is used to balance inter-cell load and handover rate, can be defined by the equation (1), which takes into consideration the cost for congesting call due to overload and the cost functions of inter-VBS soft handover and inter-cluster:

$${c}_{1} {\sum }_{k} {sc}_{k} + {c}_{2} {\sum }_{i} {\sum }_{j} {h}_{ij} {z}_{ij} + {c}_{3} {\sum }_{i} {\sum }_{j} {h}_{ij} ( {w}_{ij} - {z}_{ij} ) . \qquad ( 1 )$$

Next let us consider restriction condition for the target cost function. Firstly, each cell shall belong to a certain cell cluster, that is,

$${\sum }_{k} {x}_{ik} = 1 , for all i \qquad ( 2 )$$

Two cells within the same cluster k shall satisfy with the following condition: when and only when xᵢₖ=xⱼₖ=1, wᵢⱼₖ=1, that is,
wᵢⱼₖ≦xᵢₖ, wᵢⱼₖ≦xⱼₖ, wᵢⱼₖ≧xᵢₖ+xⱼₖ−1, for all i, j and k. (3)

Such a relationship also occurs in different cells within the same VBS, that is,
zᵢⱼₘ≦xᵢₖ, zᵢⱼₘ≦xⱼₘ, zᵢⱼₘ≧xᵢₘ+xⱼₘ−1, for all i, j and m. (4)

As for the interconnection characteristic of the cells within a cluster, the method as disclosed in G. I. Nemhauser and L. A. wolsey, Integer and Combinatorial Optimization. New york: Wiley, 1988 can be employed. If the cluster k has the interconnection characteristic, any method for dividing the set of cell CBSₖ as least includes one common border. Assume S1ₖ is a sub set of CBSₖ, that is, S1ₖ⊂CBSₖ, S1ₖ≠Ø and S1ₖ≠CBSₖ. In addition, assume S2ₖ is a complementary set for S1ₖ, that is, S2ₖ=CBSₖ−S1ₖ. As these two subsets are associated with each other, and there is at least one common border, the following can be deduced:

$${\sum }_{i ∈ S {1}_{k}} {\sum }_{j ∈ S {2}_{k}} {B}_{ij} \geq 1 \qquad ( 5 )$$

where, if cell i is adjacent to cell j, Bᵢⱼ=1.

As for the compactness, a restriction condition is defined by restricting the compactness indicator (CI) of handover border. In the equation (6), the left represents the number of inter-cluster handover borders.

$${\sum }_{i} {\sum }_{i ≺ j} {w}_{ij} {B}_{ij} \leq CI {\sum }_{i} {\sum }_{i ≺ j} {B}_{ij} \qquad ( 6 )$$

In summary, the strategy for selection of cluster can be implemented by resolving the minimized cost function and these five restriction conditions (2)-(6).

In a preferred embodiment according to the present invention, load TDᵢ of each cell and transfer probability pᵢⱼ from cell i to cell j of the user equipment are obtained from the information collected by the mobile server, whereby the strategy for intelligently adjusting size of cluster can be implemented according to information in the mobile server.

While the invention is described through above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

We claim:

1. A method for implementing macro-diversity management by using an intelligent VBS, wherein each VBS area includes a plurality of cell clusters and each VBS area corresponds to one mobile server, and the mobile server contains load information and handover information of all cells included in the VBS area, the method comprising the steps of:
a base station in a cell cluster, which has highest load and highest normalized handover rate, is selected as a parent base station, and the selected parent base station performs macro-diversity on signals from a same user equipment received by all cells of the cell cluster;
selection of cluster is made based on the following minimized target cost functions:
$${c}_{1} {\sum }_{k} {sc}_{k} + {c}_{2} {\sum }_{i} {\sum }_{j} {h}_{ij} {z}_{ij} + {c}_{3} {\sum }_{i} {\sum }_{j} {h}_{ij} ( {w}_{ij} - {z}_{ij} ) . \qquad ( 1 )$$
where:
$${\sum }_{k} {x}_{ik} = 1 , for all i , \qquad ( 2 )$$
wijk≦xik, wijk≦xjk, wijk≧xik+xjk−1, for all i, j and k (3)
zijm≦xik, zijm≦xjm, zijm≧xim+xjm−1, for all i, j and m (4)
$$\begin{matrix}{\sum }_{i ∈ S {1}_{k}} {\sum }_{j ∈ S {2}_{k}} {B}_{ij} \geq 1 & ( 5 ) \\ {\sum }_{i} {\sum }_{i ≺ j} {w}_{ij} {B}_{ij} \leq CI {\sum }_{i} {\sum }_{i ≺ j} {B}_{ij} & ( 6 )\end{matrix}$$
where:
c, c2 and c3 represent respective weights of these three cost functions in total cost function, and c1+c2+c3=1;
i, j denote cells i and j;
k denotes cell cluster, and m denotes VBS;
SCₖ is soft capacity of cell cluster k;
hᵢⱼ is handover loading from cell i to cell j;
zᵢⱼ=1−Σₘzᵢⱼₘ, where zᵢⱼₘ is a binary variable, and when cells i and j belong to VBS m, zᵢⱼₘ=1;
wᵢⱼ=1−Σₖwᵢⱼₖ, where wᵢⱼₖ is a binary variable, and when cells i and j belong to cell cluster k, wᵢⱼₖ=1;
xᵢₖ is a binary variable, and when cell i belongs to cell cluster k, xᵢₖ=1;
xⱼₖ is a binary variable, and when cell j belongs to cell cluster k, xⱼₖ=1;
xᵢₘ is a binary variable, and when cell i belongs to VBS m, xᵢₘ=1;
xⱼₘ is a binary variable, and when cell j belongs to VBS m, xⱼₘ=1;
if cell i is adjacent to cell j, Bᵢⱼ=1;
S1ₖ is a subset of CBSₖ, that is, S1ₖ⊂CBSₖ, S1ₖ≠Ø and S1ₖ≠CBSₖ;
S²ₖ is a complementary set for S1ₖ, and S2ₖ=CBSₖ−S1ₖ;
CBSₖ is a set of cells included in cell cluster k.

2. The method as defined in claim 1, wherein different VBSs can exchange information between each other through the mobile server, whereby macro-diversities of inter-cluster and inter-VBS are performed.

3. The method as defined in claim 1, wherein if there is a multiple-services user in a cell, the user with higher data rate is normalized into several users with lower data rate.

4. The method as defined in claim 1, wherein requirements for transmit power of user equipment is reduced by means of the parent base station performing macro-diversity on signals from the same user equipment received by all cells of the cell cluster, and interference level and load of uplink of the cell are also reduced.

5. The method as defined in claim 1, the selection of the parent base station is adaptively adjusted based on information about inter-cell load change and handover change collected by the mobile server and change of size of the cell cluster.

6. The method as defined in claim 1, wherein the mobile server is a database, which contains the load information and handover information of all cells included in a VBS area.

7. The method as defined in claim 1, the base stations in all cells of VBS area are connected to the mobile server in a wired manner, handover information of all users in a VBS area and load information of each cell are transmitted to the mobile server through base station, and the statistical information is obtained from the mobile server.
